(19) United States
(12) Patent Application Publication
(10) Pub. No.: US 2004/0227051 A1
(43) Pub. Date: Nov. 18, 2004

(54) Floating structural object protection system

(76) Inventor: Lyndell Kevin Bishop, Shawnee, OK (US)

Correspondence Address: Lyndell Kevin Bishop, 109 West Midland Street, Shawnee, OK, 74804, US

(21) Appl. No.: 10/435,904

(22) Filed: May 12, 2003

(51) Int. Cl. F16M 13/00

(52) U.S. Cl. 248/615

(57) ABSTRACT

A floating structural object protection system protects properties and lives from collisions occurring within waterways. The system generally comprises a pliable barrier and ballast container that allows it float partially submerged in water. According to the theory of the invention, the impact force resulting from a collision is less than the striking force by the principle of energy being released into space as the results of an inelastic collision (impulse-momentum theorem). The concept of the present invention is much improved over current devices used to protect structural objects, as it adjusts to water levels to always remain in position relative to surface craft and provides specific protection to each structural object instead of protection to the general area where structural objects are located. The system further comprises a means for refilling the medium into the cell structure, a rotational stabilizing means, a number of cell structures in cell structure, and segmental cell structures in series, parallel and loop arrangements. The system can be applied to bridge piers, dock piers, oil platform piers, building piers, buoys or any other structural object constructed in waterways, for the protection of properties and lives to enhance a safe and prosperous living environment.

### CROSS REFERENCE TO RELATED APPLICATIONS

Not Applicable

### STATEMENT REGARDING FEDERALLY FUNDED RESEARCH OR DEVELOPMENT

Not Applicable

### BACKGROUND OF THE INVENTION

The present invention relates to the protection for Properties and lives by reducing the impact force from collisions. The present invention provides protection for structural objects constructed in waterways such as bridge piers, building supports and columns, dock piers, oil platform piers and buoys when a collision occurs.

The conception of the invention originated when on May 26, 2002 a barge collided with a bridge pier on Interstate 40 near Webbers Falls, Okla., resulting in the collapse of the structure and the deaths of 14 motorists, and the closing of a major interstate highway for 2 months. The applicant, remembering other barge-structure collisions that resulted in loss of life, questioned if a practical solution to these collisions could be found, in which if not completely abating damage to the structure, could diminish the force from the collision, thus increasing the time in which emergency procedures could take place. The applicant has been active in bridge design and construction for 14 years.

Description of the Prior Art

Inflatable fluid cushions and air bags have been invented to provide impact cushioning and absorbing for passengers in vehicles. They are sensitive to the impact of the vehicles. The passengers are restrained by the cushions or air bags. See, for example, U.S. Pat. Nos. 2,781,203; 3,514,125; 3,514,125; 3,927,901; 3,964,255 and 4,565,535.

Impact bumpers have been invented for vehicles to absorb impact upon bumping against other objects. See, samples of U.S. Pat. Nos. 3,655,321 and 3,960,397.

Earthquake protection apparatuses of isolation, suspension and spring connection have been invented to protect equipment and structures. They are the means of energy absorbing of force sliding due to vibration or earthquake. See U.S. Pat. Nos. 4,330,103; 4,351,515 and 4,644,714.

A vibration damper has been invented for damping vibration from all directions. The application of this invention is limited to a constant force with a square wave pattern. See U.S. Pat. No. 3,145,012.

Isolating platforms have been invented for absorbing or cushioning as a shock or impact resistant. See U.S. Pat. Nos. 3,351,027 and 3,679,159.

A cushioning device for protection of passengers in a traveling vehicle has been invented. It comprises an inflatable cushioning bag, an unfoldable inflating bag, an impact sensing means and air passing holes or valves. See U.S. Pat. No. 3,843,150.

An mechanical type object protection system has been invented. It comprises a forcing system and an energy releasing means to reduce a striking force. See U.S. Pat. No. 5,915,663.

None of the above cited prior art references apply the same theory and principle as the present invention. The theory of the present invention states that the impact force is reduced by the principle of the energy force released by the deformation of the system. Therefore, the system has protected the structural object.

### BRIEF SUMMARY OF THE INVENTION

The present invention is a floating structural object protection system. The system reduces the impact force by the principle of the energy force being released by the deformation of the cell structure and release of the medium, and an increased impact time, which results in an inelastic collision, in which the momentum is constant, but the kinetic energy is not. In theory, the present invention decreases the striking force to protect properties and lives in case of collision.

The said system floats on the water and uses a ballast structure to keep the cell structure a sufficient distance below the waterline to minimize rotation during the moment of collision. The ballast structure has a stabilizer fin that keeps the cell structure from rotating horizontally in water currents.

The floating structural object protection system comprises at least one cell structure, at least one ballast structure, medium, and force releasing means, wherein the system receiving said striking force acts on said cell structure containing said medium thereby forms a forcing system and creates an energy force, said energy force releases from said forcing system into a space by deformation of the said cell structure and release of the medium. The reacting force responding to the forcing system in the direction opposite to the striking force is less than the striking force.

### BRIEF DESCRIPTION OF SEVERAL VIEWS OF THE DRAWING

FIG. 1 is the plan view of the schematic presentation of the principle, function and installation of the floating object protection system, performing in a model which is not limited to the application, construction, improvement and refinement of the present invention.

FIG. 2 is the side elevation of the schematic presentation of the principle, function and installation of the floating object protection system, performing in a model which is not limited to the application, construction, improvement and refinement of the present invention

FIG. 3 is the plan view of the system, installed on an object, before the striking of the impact force.

FIG. 4 is the plan view of the system, installed on an object, presenting the working mechanics during the action of the impact force.

FIG. 5 is the plan view of the system, showing the action of the system in water currents.

FIG. 6 is the side elevation of the system, showing the action of the system as the water level changes.

FIG. 7 is a plan view showing the segmental installation of the system on a cylindrically shaped pier.

FIG. 8 is a plan view showing the segmental installation of the system on an elliptically shaped pier.

FIG. 9 is a plan view showing the segmental installation of the system on a series of cylindrically shaped piers which are joined by a connecting wall.

FIG. 10 is the plan view of two circular segments of the system connected together, forming a complete system.

FIG. 11 is a section through FIG. 10

### DRAWING REFERENCE NUMERALS

1 Structural object

2 Pliable Fluid Filled Barrier/Cell Structure

3 Ballast Container

4 Ballast Material

5 Stabilizer Fin

6 Semi-Rigid Casing

7 Pressure Relief Valve

8 Water Level

9 Bottom of Waterway

10 Medium

11 Direction of Water Flow around Barrier

12 Water Flow Direction

13 Water Level at Time ‘A’

14 Water Level at Time ‘B’

15 Impact Force

16 Reacting Force

17 Reacting Forces of Medium, Internal

18 Pressure Relief Force

19 Reacting Force of Pressure Relief

20 Inflation Valve

### DETAILED DESCRIPTION OF THE INVENTION

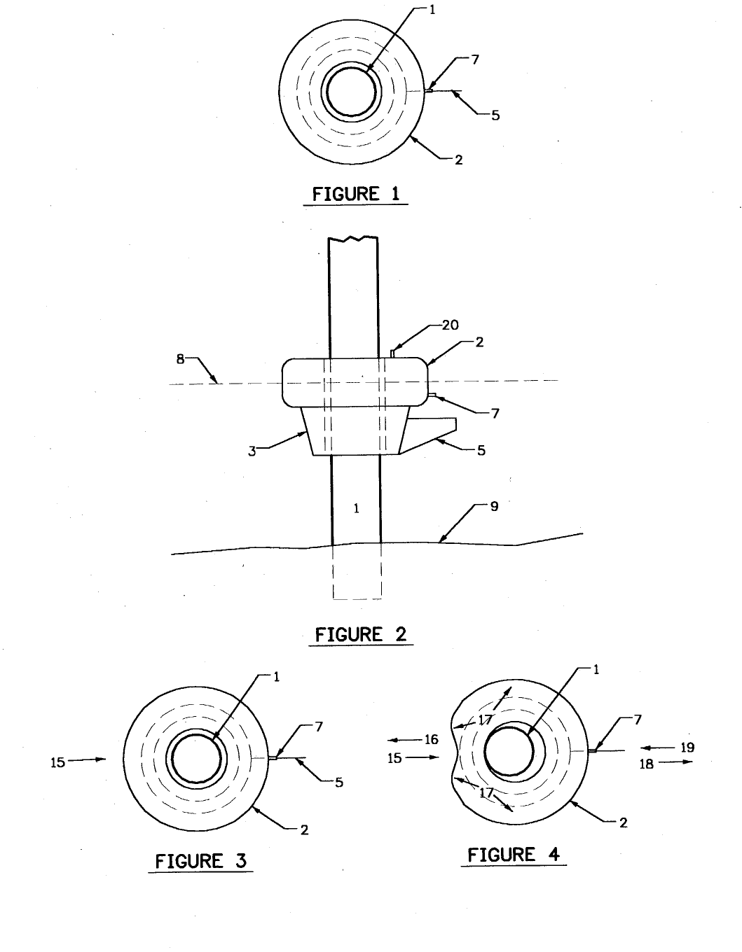

Referring to FIG. 1 of the drawings, herein is shown a preferred embodiment of the floating structural object protection system of the present invention by means of a schematic installation model. It comprises a cell structure 2 surrounding a structural object 1, and having at least one force releasing means 7, and one stabilizing means 5.

Referring to FIG. 2 of the drawings, herein is shown a preferred embodiment of the floating structural object protection system of the present invention by means of a schematic installation model. It comprises a cell structure 2 surrounding a structural object 1, and having at least one force releasing means 7, one inflating means 20, one stabilizing means 5, and one ballast structure 3, which contains ballast material. The medium in said cell structure 2, in combination with the ballast structure 3, allows said cell structure 2, to float partially submerged in relation to water level 8. Which is a distance above the waterway bottom 9.

Referring to FIG. 3 of the drawings, herein is shown a preferred embodiment of the floating structural object protection system of the present invention by means of a schematic working model. It comprises a cell structure 2 surrounding a structural object 1, and having at least one force releasing means 7, and one stabilizing means 5, represented just before the moment of collision from the impact force 15.

Referring to FIG. 4 of the drawings, herein is shown a preferred embodiment of the floating structural object protection system of the present invention by means of a schematic working model. It comprises a cell structure 2 surrounding a structural object 1, and having at least one force releasing means 7, and one stabilizing means 5, represented during the time of the impact force 15. Said impact force 15, acts on the cell structure 2, which results in a resulting force 16, from the structural object 1, and results in an internal reacting force 17 from the medium contained in said cell structure 2. When said impact force 15 acts on said cell structure 2, the deformation of said cell structure 2, creates pressure from the internal forces 17, which, when reaching a predetermined pressure, activates the pressure relief valve 7, which allows the impact force 15, to stay in contact with the cell structure 2 for a longer period of time, thus decreasing the impact force.

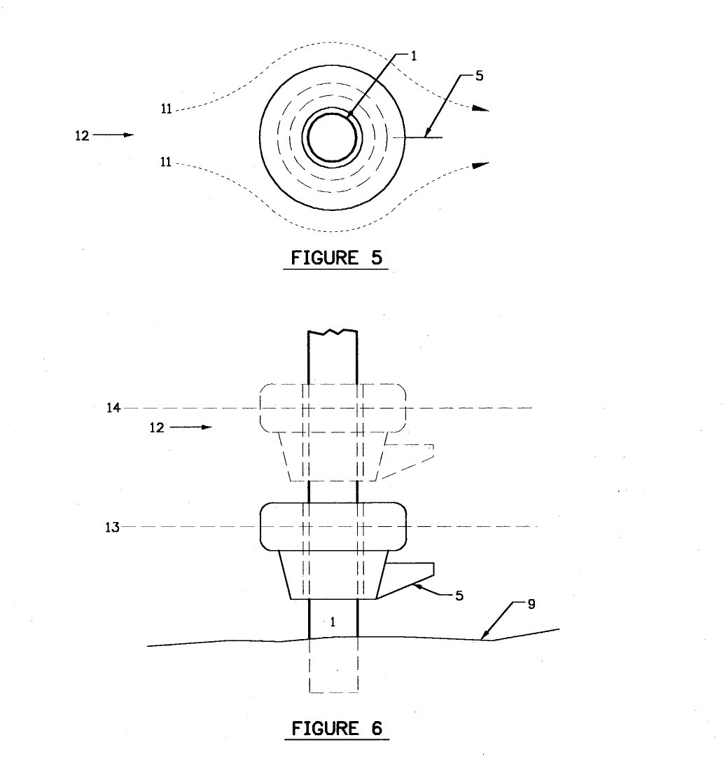

FIG. 5 shows the present invention, in the plan view, installed on a cylindrically shaped structural object 1, with the stabilizer fin 5 acting to stabilize the system when water currents 11 are present. The stabilizer fin 5, turns to conform to the water flow direction 12.

FIG. 6 shows the present invention, in the elevation view, installed on a structural object 1, as it adjusts to change in water levels. As the water level rises, a distance above the waterway bottom 9, from the water level at time ‘A’ 13, to the water level at time ‘B’ 14, the system rises accordingly.

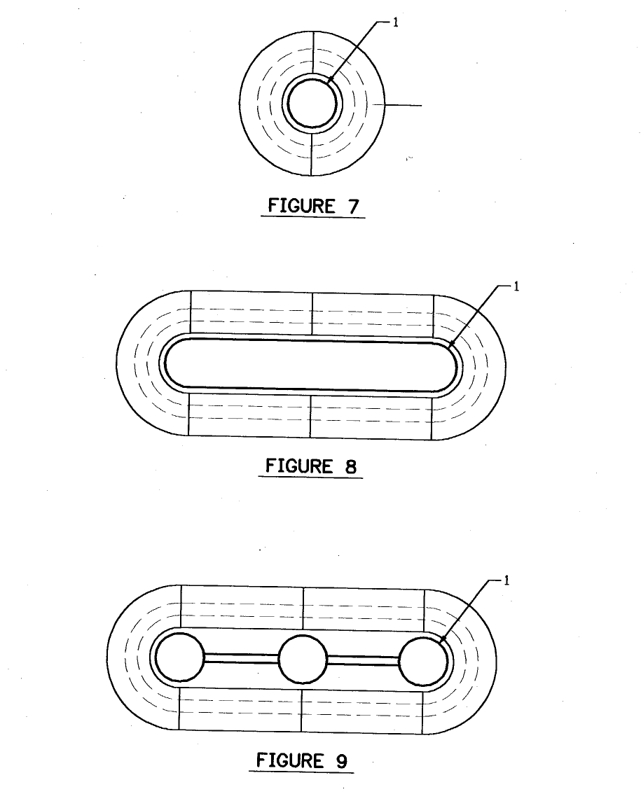

FIG. 7 of the drawings shows a plan view of a preferred embodiment of the floating structural object protection system as related to the segmental installation on a cylindrically shaped structural object 1. The system is installed as two semi-circular segments.

FIG. 8 of the drawings shows a plan view of a preferred embodiment of the floating structural object protection system as related to the segmental installation on a oval shaped structural object 1. The system is installed as a series of semi-circular and straight segments.

FIG. 9 of the drawings shows a plan view of a preferred embodiment of the floating structural object protection system as related to the segmental installation on a series of cylindrically shaped structural objects 1 joined by a connecting member. The system is installed as a series of semi-circular and straight segments.

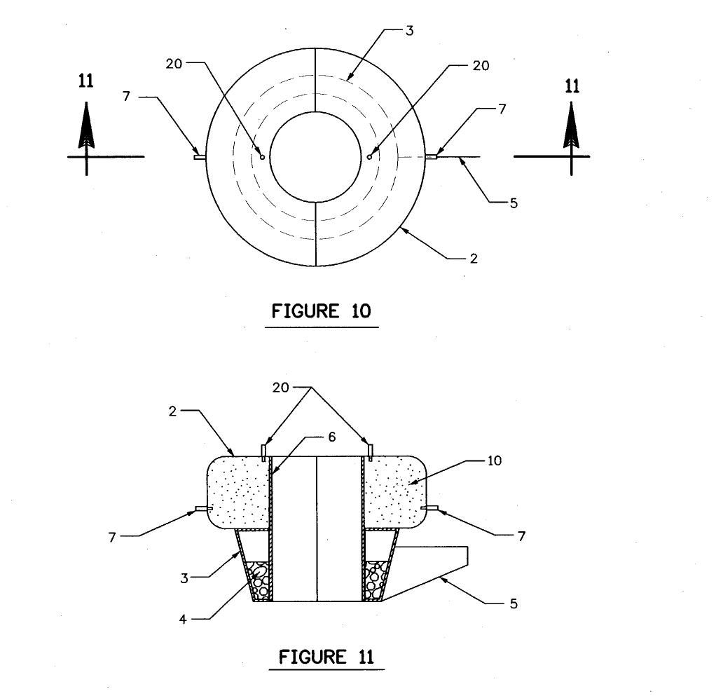

FIG. 10 is the plan view of two circular segments of the system connected together, forming a complete system, consisting of a cell structure 2, a ballast container 4, a stabilizing fin 5, a pressure relief valve 7 and inflation valve 20.

FIG. 11 is a section through the floating structural object protection system showing the envisioned construction of such. The cell structure 2, containing a medium 10, is attached to the semi-rigid casing 6 which is attached to the ballast container 3, which holds the ballast material 4. The stabilizer fin 5 is attached to the ballast container 3. The pressure relief valve 7 is attached to the cell structure 2 to allow for pressure release from the medium 10. The inflating valve 20 is connected to the cell structure 2 to allow for introducing the medium 10 into said cell structure.

I claim:

1. A floating structural object protection system comprising at least one cell structure made of an elastic material containing a medium or air, gas, fluid or foam that allows the cell structure to float on the water, mounted on a ballast structure containing a means for retaining a ballast material, said ballast structure may have a stabilizing fin, whereby, when an impact force strikes the cell structure, creating an energy force, a reacting force responding to the impact force is less than the impact force of a collision with a structural object that does not employ the present invention, due to the release of energy through deformation of the cell structure, release of the medium and the increased time of impact on the cell structure thus decreasing the kinetic energy of the collision, thus protecting a structural object.
